(19) United States
(12) Patent Application Publication
(10) Pub. No.: US 2016/0035062 A1
(43) Pub. Date: Feb. 4, 2016

(54) ELECTRONIC APPARATUS AND METHOD

(71) Applicant: KABUSHIKI KAISHA TOSHIBA, Tokyo (JP)

(72) Inventor: Koji Yamamoto, Ome Tokyo (JP)

(21) Appl. No.: 14/880,012

(22) Filed: Oct. 9, 2015

Related U.S. Application Data
(63) Continuation of application No. PCT/JP2013/060848, filed on Apr. 10, 2013.

(51) Int. Cl. G06T 3/00; G06T 7/00; G06T 3/40; G06F 3/0485; G06F 3/0488

(52) U.S. Cl. CPC G06T 3/0093; G06F 3/0485; G06F 3/0488; G06T 3/403; G06T 7/0081; G06T 7/0085; G06T 7/0089; G06T 2207/20132; G06T 2210/22

(57) ABSTRACT

According to one embodiment, an electronic apparatus includes a processor. The processor is configured to display a first image and a quadrangular selection frame on a display region of a display screen. The processor is configured to deform the selection frame based on a deform selection input. The processor is configured to reduce or enlarge the first image based on a position of a first point on the selection frame moved by the deformation.

### CROSS-REFERENCE TO RELATED APPLICATIONS

This application is a Continuation Application of PCT Application No. PCT/JP2013/060848, filed Apr. 10, 2013, the entire contents of which are incorporated herein by reference.

### FIELD

Embodiments described herein relate generally to a technique of selecting a portion of an image.

### BACKGROUND

When an object having a rectangular outline is imaged from an oblique direction, the rectangular outline in the image is distorted. Electronic apparatuses configured to obtain the shape of the outline of an object by generating an edge image from an image containing the distorted rectangular outline and to correct the distortion based on the focal distance at which the image is captured or the like have been proposed.

In a case where an outline is not completely displayed in an image, the edge image cannot be generated automatically, and therefore the user needs to set a region for generating an edge image using a selection frame.

In this case, it is necessary to temporarily reduce the image and deform the selection frame so as to move a vertex of the selection frame to an estimated position of a corner of the object. Further, when the image is reduced too much, it is necessary to enlarge the image. Here, in the conventional methods, the user needs to perform a scaling operation (such as a pinch-in operation or a pinch-out operation) and a deforming operation of the selection frame separately, and in fact, the user is required to perform complicated operations.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective diagram showing an example of an appearance of an electronic apparatus of an embodiment.

FIG. 2 is a block diagram showing an example of a system configuration of the electronic apparatus of the embodiment.

FIG. 3 is a block diagram showing an example of the structure of an image processing program.

FIG. 4 illustrates a state of displaying an image corresponding to the image file of a whiteboard.

FIG. 5 illustrates an image and a selection frame in a case where a select button shown in FIG. 4 is operated.

FIG. 6 illustrates a state of displaying the reduced image.

FIG. 7 illustrates a state of selecting a region in the image by the selection frame.

FIG. 8 illustrates an image cropped by a cropping processor.

FIG. 9 illustrates an image corrected to a rectangular shape by a correction processor.

FIG. 10 illustrates a state of displaying the enlarged image.

FIG. 11 is a flowchart showing a procedure of enlargement and reduction processing by the display processor.

### DETAILED DESCRIPTION

Various embodiments will be described hereinafter with reference to the accompanying drawings.

In general, according to one embodiment, an electronic apparatus includes a processor. The processor is configured to display a first image and a quadrangular selection frame on a display region of a display screen. The processor is configured to deform the selection frame based on a deform selection input. The processor is configured to reduce or enlarge the first image based on a position of a first point on the selection frame moved by the deformation.

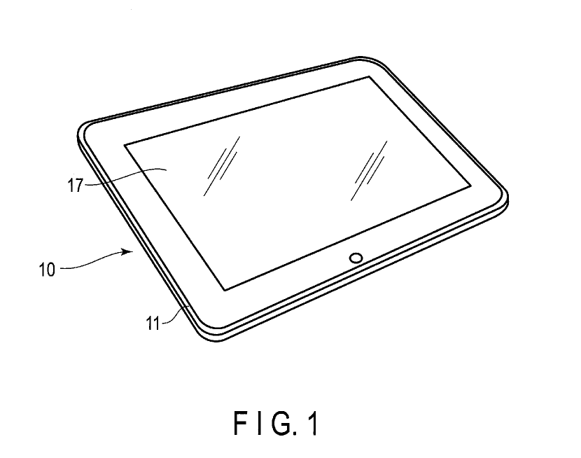

FIG. 1 is a perspective diagram showing an appearance of an electronic apparatus of an embodiment. The electronic apparatus may be realized as an embedded system incorporated in various electronic apparatuses such as a tablet computer, a notebook-size personal computer, a smartphone, a personal digital assistant (PDA) and a digital camera. The following descriptions are based on the assumption that the electronic apparatus is realized as a tablet computer 10. The tablet computer 10 is a portable electronic apparatus which is also called a tablet or a slate computer, and includes a body 11 and a touchscreen display 17 as shown in FIG. 1. The touchscreen display 17 is attached to the body 11 in such a manner as to be overlaid on the upper surface of the body 11.

The body 11 includes a thin box-shaped housing. In the touchscreen display 17, a flat panel display and a sensor which is configured to detect a contact position of a stylus or a finger on the screen of the flat panel display are incorporated. The flat panel display may be, for example, a liquid crystal display (LCD). As the sensor, for example, a capacitive touchpanel, an electromagnetic induction digitizer or the like may be used.

Further, on the back surface side of the body 11, a camera module configured to capture an image is provided.

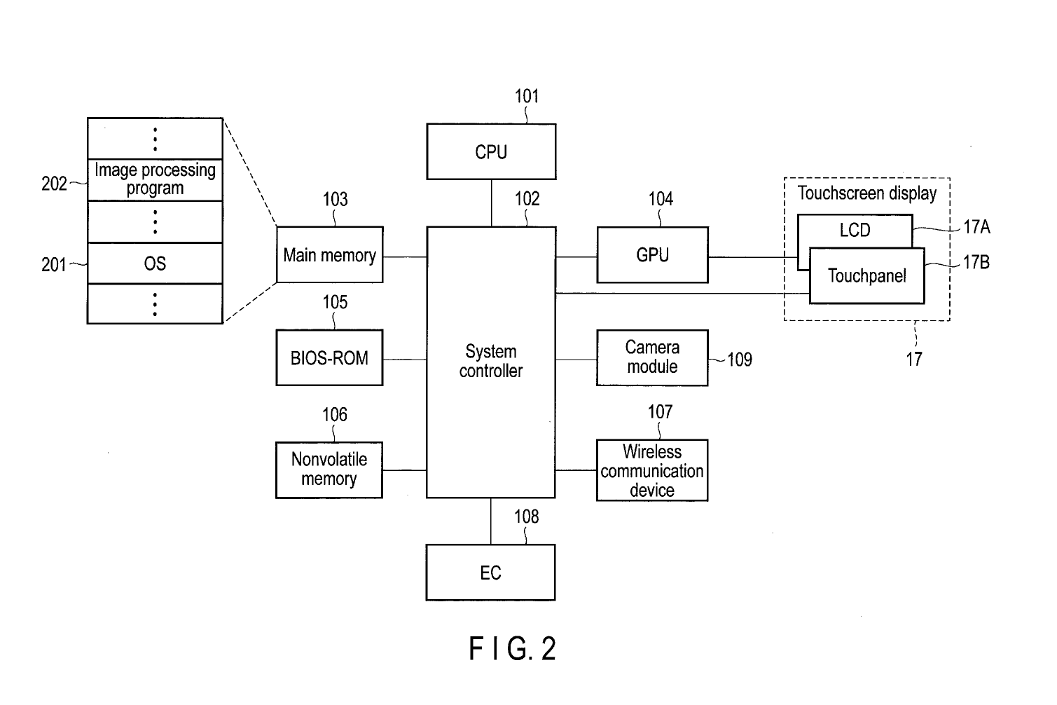

FIG. 2 illustrates a system configuration of the tablet computer 10.

The tablet computer 10 includes, as shown in FIG. 2, a central processing unit (CPU) 101, a system controller 102, a main memory 103, a graphics processing unit 104, a BIOS-ROM 105, a nonvolatile memory 106, a wireless communication device 107, an embedded controller (EC) 108, a camera module 109 and the like.

The CPU 101 is a processor configured to control operations of various modules in the tablet computer 10. The CPU 101 executes various kinds of software loaded from a storage device, namely, the nonvolatile memory 106 to the main memory 103. The software includes an operating system (OS) 201 and various application programs. The application programs include an image processing program 202. The image processing program 202 includes, for example, a function of correcting a quadrangular selection region selected in an image corresponding to the image file captured by the camera module 109, to a rectangular shape.

Further, the CPU 101 also executes a basic input/output system (BIOS) stored in the BIOS-ROM 105. The BIOS is a program for hardware control.

The system controller 102 is a device configured to connect the local bus of the CPU 101 and various components. The system controller 102 includes a built-in memory controller configured to perform access control of the main memory 103. Further, the system controller 102 also includes a function of executing a communication with the GPU 104 via a serial bus conforming to the PCI Express standard or the like.

The GPU 104 is a display controller configured to control an LCD 17A used as a display monitor of the tablet computer 10. The GPU 104 generates a display signal and transmits the display signal to the LCD 17A. The LCD 17A displays a screen image based on the display signal. On the LCD 17A, a touchpanel 17B is provided.

The wireless communication device 107 is a device configured to execute a wireless communication such as a wireless LAN or a 3G mobile communication. The EC 108 is a single-chip microcomputer including an embedded controller for power management. The EC 108 includes a function of powering the tablet computer 10 on and off based on the user's operation of the power button.

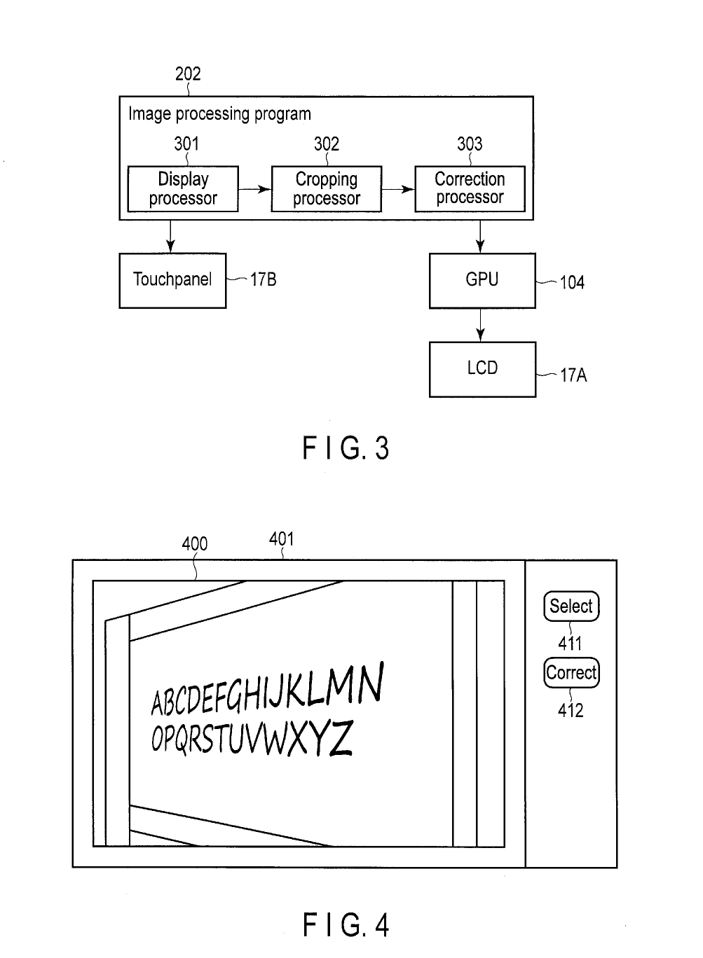

FIG. 3 is a block diagram showing a structure of the image processing program 202.

The image processing program 202 includes a display processor 301, a cropping processor 302, a correction processor 303 and the like.

The display processor 301 is configured: to execute processing to display on the display screen, namely, the LCD 17A, a background image indicating a display region of an image and an image to be displayed on the background image based on an image file; to perform an operation to reduce or enlarge the images; to execute processing to display on the LCD 17A the background image, the image on the background image, and a quadrangular selection frame on the image; and the like. In the image file, an exchangeable image file format (EXIF) containing the conditions under which the image was captured, such as the focal length of the lens used or the like is embedded.

The display processor 301 generates display data to perform display on the LCD 17A. The operating system 201 transmits display data based on the generated display data to the GPU 104. The GPU 104 generates a display signal based on the transmitted data and outputs the generated display signal to the LCD 17A. The LCD 17A displays an image based on the display signal.

The selection frame is displayed in such a manner as to be overlaid on the image. The display processor 301 is configured to deform the selection frame based on an input from the input module, namely, the touchpanel 17B and display the deformed selection frame. The input (deform selection input) from the touchpanel 17B includes a user's instruction to move a point (vertex) of the selection frame.

The display processor 301 enlarges or reduces the image based on the position of a point on the selection frame moved in the deformation. The display processor 301 enlarges or reduces the image at a speed according to the position of the point on the selection frame moved in the deformation.

The cropping processor 302 is configured to execute processing to crop an image of a quadrangular region selected by a selection frame. The correction processor 303 is configured to execute processing to correct the image of the cropped region to a rectangular shape based on the focal distance at which the image is captured. When the region selected by the selection frame includes an image and a background image, the cropping processor 302 crops the image as well as the background image.

FIG. 4 illustrates a state of displaying an image corresponding to the image file (image data) of a whiteboard imaged by the camera module 109. As shown in FIG. 4, the upper right corner and the lower right corner of the whiteboard are not shown in an image 400. On the right-hand side of a region 401, a control panel including a select button 411 and a correct button 412 is displayed. By touching one of operation points P1 to P8 on a selection frame 501 and sliding the point while touching it, the user can deform the selection frame 501.

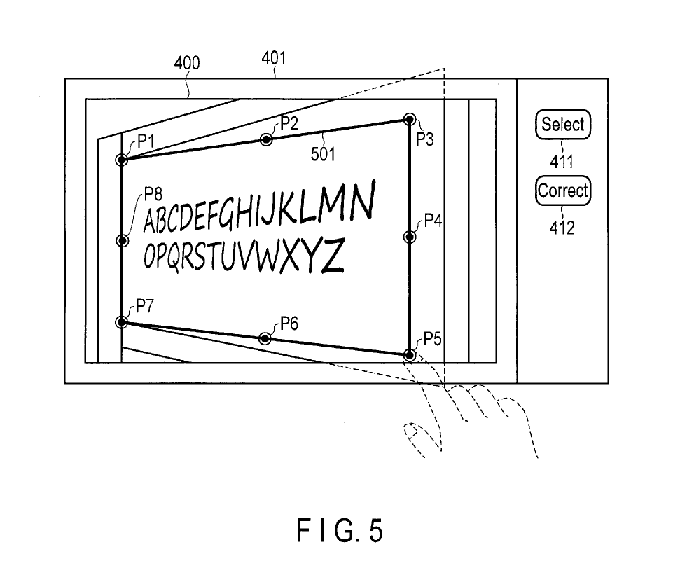

In this state, when the select button 411 is operated, the display processor 301 displays a selection frame. As shown in FIG. 5, the selection frame 501 for selecting a writing region of the whiteboard in which a letter is written or a picture is drawn is displayed. In FIG. 5, a portion of the writing region which is not displayed is indicated by dashed lines. As shown in FIG. 5, the upper right corner and the lower right corner of the whiteboard are not displayed on the LCD 17A, and thus it is not possible to select the writing region.

The display processor 301 reduces the image 400 when a vertex of the selection frame 501 approaches the periphery of the background image 401 and displays the reduced image. When a distance D1 between a point on the selection frame moved in the deformation and the periphery of the background image 401 is less than a first set value DS1, the display processor 301 reduces the image 400 at a speed according to distance D1. More specifically, the display processor 301 reduces the image 400 at a speed according to distance D1 when distance D1 between a vertex (for example, operation point P5) of the selection frame 501 and the periphery of the background image 401 is within the first set value DS1. As distance D1 decreases, the display processor 301 reduces the image 400 at a higher reduction speed.

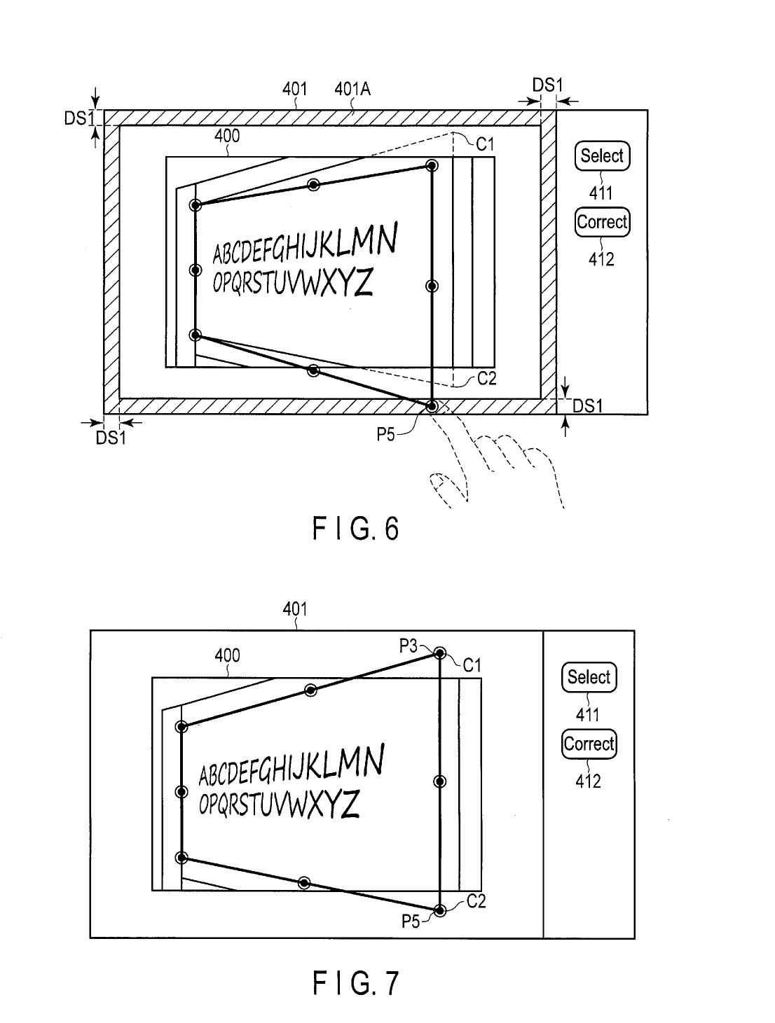

By displaying the reduced-size image, a point C1 estimated to be the upper right corner of the writing region and a point C2 estimated to be the lower right corner of the writing region are positioned on the display region, that is, on the background image as shown in FIG. 6.

At this time, the user moves the operation point which the user is currently operating to the outside of a region 401A. By moving the operation point to the outside of the region 401A, the reduction speed is set to zero. Therefore, the image 400 is displayed at the reduction ratio which had been set immediately before the operation point was moved to the outside of the region 401A.

By displaying the reduced-size image 400, it is possible to move operation points P3 and P5 of the selection frame 501 to points C1 and C2 estimated to be the virtual upper right corner and lower right corner of the whiteboard as shown in FIG. 7. Therefore, a quadrangular region including the writing region can be selected by the selection frame 501.

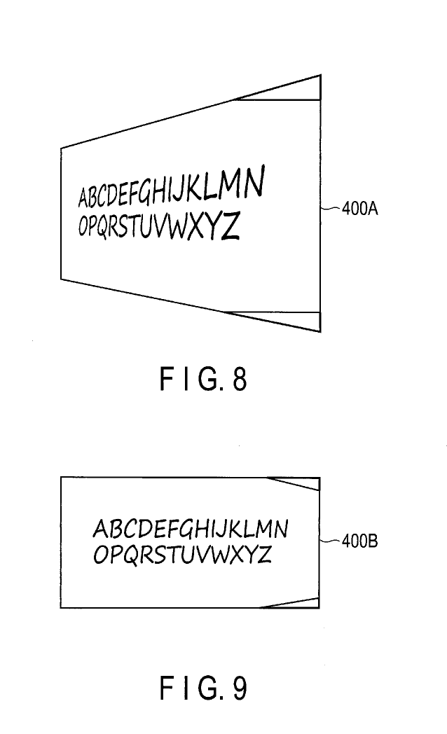

When the correct button 412 is operated after the selection by the selection frame 501 is complete, the cropping processor 302 crops the region selected by the selection frame 501. As shown in FIG. 8, an image 400A including the image 400 and the back ground 401 is cropped. After being cropped, the cropped image 400A is corrected by the correction processor 303 to a rectangular shape. FIG. 9 illustrates a corrected rectangular image 400B.

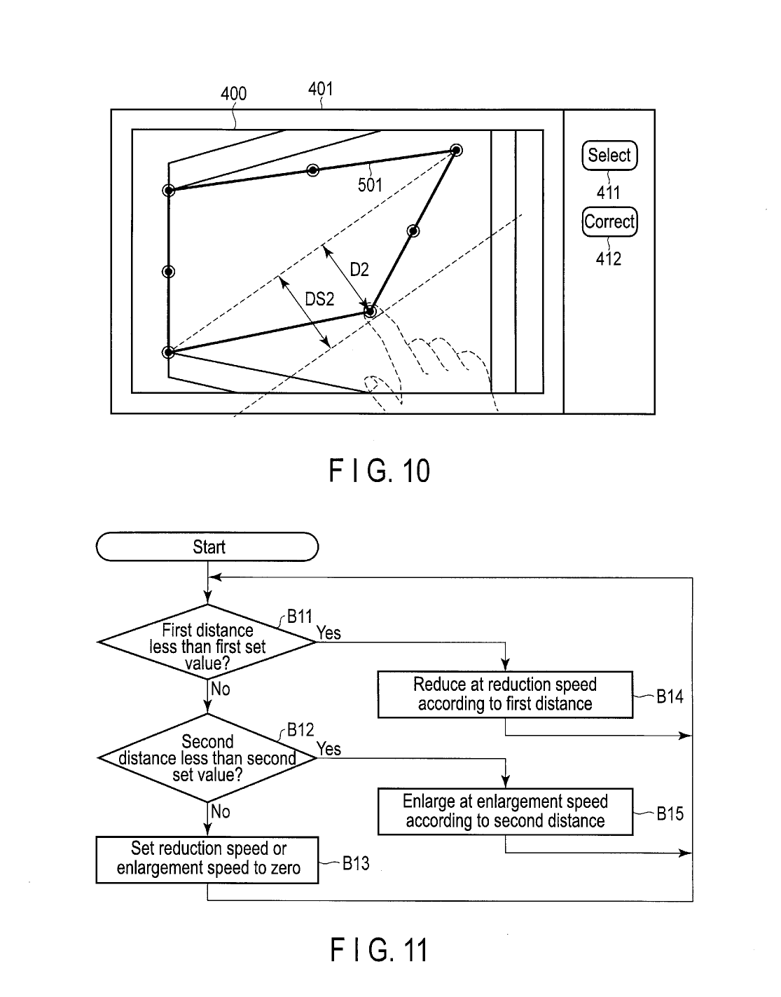

Note that, as shown in FIG. 10, the display processor 301 enlarges the image 400 when a vertex is moved closer to the center of the selection frame 501 and displays the enlarged image.

More specifically, when a distance D2 between a vertex of the selection frame moved in the deformation and a diagonal line connecting two vertices adjacent to the vertex is less than a second set value DS2, the display processor 301 enlarges the image 400 at a speed according to distance D2. In other words, the display processor 301 enlarges the image 400 at a speed according to distance D2 when distance D2 between a point on the selection frame 501 moved in the deformation and the center of the selection frame becomes less than the second set value DS2. The display processor 301 enlarges the image 400 at a higher enlargement speed as distance D2 decreases.

FIG. 11 is a flowchart showing a procedure of enlargement and reduction processing by the display processor 301.

The display processor 301 determines whether the first distance D1 indicating the shortest distance between a moving vertex of the selection frame 501 and the periphery of the background image 401 is less than the first set value DS1 or not (block B11). When it is determined to be less (yes in block B11), the display processor 301 reduces an image at a reduction speed according to the value of the first distance D1 (block B14). When it is determined not to be less (no in block B11), the display processor 301 determines whether the second distance D2 indicating the distance between the moving vertex of the selection frame 501 and the diagonal line connecting two vertices adjacent to the moving vertex is less than the second set value DS2 (block B12). When it is determined to be less (yes in block B12), the display processor 301 enlarges the image at an enlargement speed according to the value of the second distance D2 (block B15). When it is determined not to be less (no in block B12), the reduction speed or the enlargement speed is set to zero.

Note that the image is neither enlarged nor reduced in a case where distance D1 is not less than the first set value DS1 and distance D2 is not less than the second set value DS2.

The display processor 301 may reduce or enlarge the image 400 at a speed according to the size of the LCD 17A.

According to the present embodiment, it is possible to perform the operation to enlarge or reduce an image and the operation to deform a selection frame without switching therebetween by enlarging or reducing the image based on the position of the first point on the selection frame 501 moved in the deformation.

Note that, since the entire image processing of the present embodiment can be implemented by software, a technical effect similar to that produced by the present embodiment can be easily achieved by installing in an ordinary computer a computer program configured to control the computer to execute the image processing via a computer-readable storage medium storing the computer program thereon and by executing the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a processor configured to:
display a first image and a quadrangular selection frame on a display region of a display screen;
deform the selection frame based on a deform selection input; and
reduce or enlarge the first image based on a position of a first point on the selection frame moved by the deformation.

2. The electronic apparatus of claim 1, wherein
the selection frame is configured to select a region in the first image.

3. The electronic apparatus of claim 1, wherein
the processor is configured to reduce the first image when a first distance between the first point and a periphery of the display region is less than a first set value.

4. The electronic apparatus of claim 1, wherein
the first point is a first vertex of four vertices of the selection frame.

5. The electronic apparatus of claim 4, wherein
the processor is configured to reduce the first image when the first distance between the first vertex and a periphery of the display region is less than a first set value.

6. The electronic apparatus of claim 1, wherein
the processor is configured to enlarge the first image when a second distance between the first point and a center of the selection frame is less than a second set value.

7. The electronic apparatus of claim 1, wherein
the first point is a first vertex of four vertices of the selection frame, and
the processor is configured to enlarge the first image when a second distance between the first vertex and a diagonal line connecting two vertices of the selection frame adjacent to the first vertex is less than a second set value.

8. The electronic apparatus of claim 1, further comprising:
the processor configured to:
crop the first image in the selection frame; and
correct the cropped image to a rectangular shape.

9. The electronic apparatus of claim 8, wherein
the processor is configured to:
display the first image on a background image; and
crop, when the selection frame selects the first image and the background image, the first image and the background image in the selection frame.

10. The electronic apparatus of claim 1, wherein
the processor is configured to reduce or enlarge the first image at a speed based on the position of the first point.

11. The electronic apparatus of claim 1, wherein
the processor is configured to reduce or enlarge the first image at a speed based on a size of the display screen.

12. A method comprising:
displaying a first image and a quadrangular selection frame on a display region of a display screen;
deforming the selection frame based on a deform selection; and
reducing or enlarging the first image based on a position of a first point on the selection frame moved by the deformation.
